(19) United States
(12) Patent Application Publication
(10) Pub. No.: US 2015/0281324 A1
(43) Pub. Date: Oct. 1, 2015

(54) INFORMATION PROCESSING APPARATUS, DEVICE CONTROL APPARATUS, METHODS OF CONTROLLING THEM, AND DEVICE CONTROL SYSTEM

(71) Applicant: CANON IMAGING SYSTEMS INC., Niigata-shi (JP)

(72) Inventor: Ryosuke MIYASHITA, Niigata-shi (JP)

(21) Appl. No.: 14/738,303

(22) Filed: Jun. 12, 2015

Related U.S. Application Data
(63) Continuation of application No. PCT/JP2013/085025, filed on Dec. 19, 2013.

(30) Foreign Application Priority Data
Dec. 21, 2012 (JP) 2012-279336

(51) Int. Cl. H04L 29/08

(52) U.S. Cl. CPC H04L 67/025; H04L 67/125

(57) ABSTRACT

To control a device using a communication path used in virtualization control between an information processing apparatus and a device control apparatus, by causing applications of the information processing apparatus and the device control apparatus to cooperate with each other. The information processing apparatus 100 is connected via a network 500 to the device control apparatus 200 having the device 300 locally connected thereto, and a virtualization control unit 100D establishes a communication path 150 with the device control apparatus to perform virtualization control of the device connected to the device control apparatus. The application 100A selects a predetermined control route, and controls the device being subjected to the virtualization control, or the device control apparatus. Further, a virtualization control API 100B provides an interface to the application 100A, for performing virtualization control and control using the communication path used in the virtualization control.

### FIELD OF THE INVENTION

The present invention relates to an information processing apparatus and a device control apparatus which are connected via a network, methods of controlling them, and a device control system.

### DESCRIPTION OF THE RELATED ART

There has been generally known a system in which an information processing apparatus, such as a personal computer (hereinafter referred to as a PC), is set as a client, and the client uses a device (peripheral device), such as a printer, a storage, and a scanner, via a network. As such a system, there is a system in which a client virtually recognizes a device on a network as a locally connected device, whereby the device is made accessible from the client on the network.

For example, to control a device that is locally connected to a device server (device control apparatus) connected to a network, such as a LAN, from a client on the network, the present applicant has proposed a device control system that makes it possible to control a device control unit (host controller) of the device server from a PC (see e.g. Japanese Patent Laid-Open Publication No. 2013-084113).

Incidentally, in the above-described device control system, the object to be controlled by the client is the device control unit (host controller) of the device server, and for example, to reset the device locally connected to the device server, it is necessary to control hardware other than the device control unit. Further, it is sometimes desired to control the device from an application (higher-layer program) installed in the client, by causing an application introduced into the device server to cooperate therewith.

In this case, a new communication path is required to be established between the client and the device server, and hence, before anything else, it is necessary to secure a network resource. Further, the communication path is generated after performing processing including determining whether a network port to be used is duplicate, and hence it takes time to connect to the device server.

### SUMMARY OF THE INVENTION

An object of the present invention is to provide an information processing apparatus, a device control apparatus, methods of controlling them, and a device control system, which make it possible to control a device by causing applications of a client and a device server to cooperate with each other using a communication path used in virtualization control between the client and the device server.

Further, an object of the present invention is to provide an information processing apparatus, a device control apparatus, methods of controlling them, and a device control system, which make it possible to control software, hardware, and firmware in a device server other than a device control unit of the device server.

### Solution to Problem

To attain the above object, the information processing apparatus according to the present invention provides an information processing apparatus that is connected via a network to a device control apparatus having a device locally connected thereto, comprising a processer configured to execute a first virtualization control task that establishes a communication path with the device control apparatus, and performs virtualization control of the device connected to the device control apparatus, a first control task that controls the device being subjected to the virtualization control by the first virtualization control task, or the device control apparatus, and a first apparatus control task that selects, in a case where the communication path is established by the first virtualization control task, a predetermined control route according to an instruction from the first control task, and performs transmission and reception of data via the control route.

The device control apparatus connected to an information processing apparatus via a network and having a device locally connected thereto, comprising a processor configured to execute a second virtualization control task that establishes a communication path with the information processing apparatus, and performs virtualization control of the device connected to the device control apparatus, a second control task that controls the device being subjected to the virtualization control by the second virtualization control task, or the information processing apparatus, and a second apparatus control task that selects, in a case where the communication path is established by the second virtualization control task, a predetermined control route according to an instruction from the second control task, and performs transmission and reception of data via the control route.

According to the present invention, it is possible to control the device by causing the information processing apparatus and the device control apparatus to cooperate with each other using the communication path used in the virtualization control between the information processing apparatus and the device control apparatus.

Further features of the present invention will become apparent from the following description of an exemplary embodiment with reference to the attached drawings.

### BRIEF DESCRIPTION OF THE DRAWINGS

FIG. 1 is a schematic block diagram of an example of a device control system according to a first embodiment of the present invention.

FIG. 2 is a sequence diagram useful in explaining connection/disconnection of a session, data transmission/reception, a request to (reset of) an apparatus control unit, connection/disconnection of a device, and start/stop of virtualization control, which are performed in the device control system shown in FIG. 1 via control routes.

FIG. 3 is a diagram useful in explaining a sequence performed when virtualization control is started by a device control apparatus in a device control system according to a second embodiment of the present invention.

FIG. 4 is a sequence diagram useful in explaining application control and hardware control of a device control apparatus using a virtualization control communication path in a device control system according to a third embodiment of the present invention.

### DESCRIPTION OF THE EMBODIMENTS

The present invention will now be described in detail below with reference to the drawings showing an embodiment thereof.

### First Embodiment

### <System Configuration>

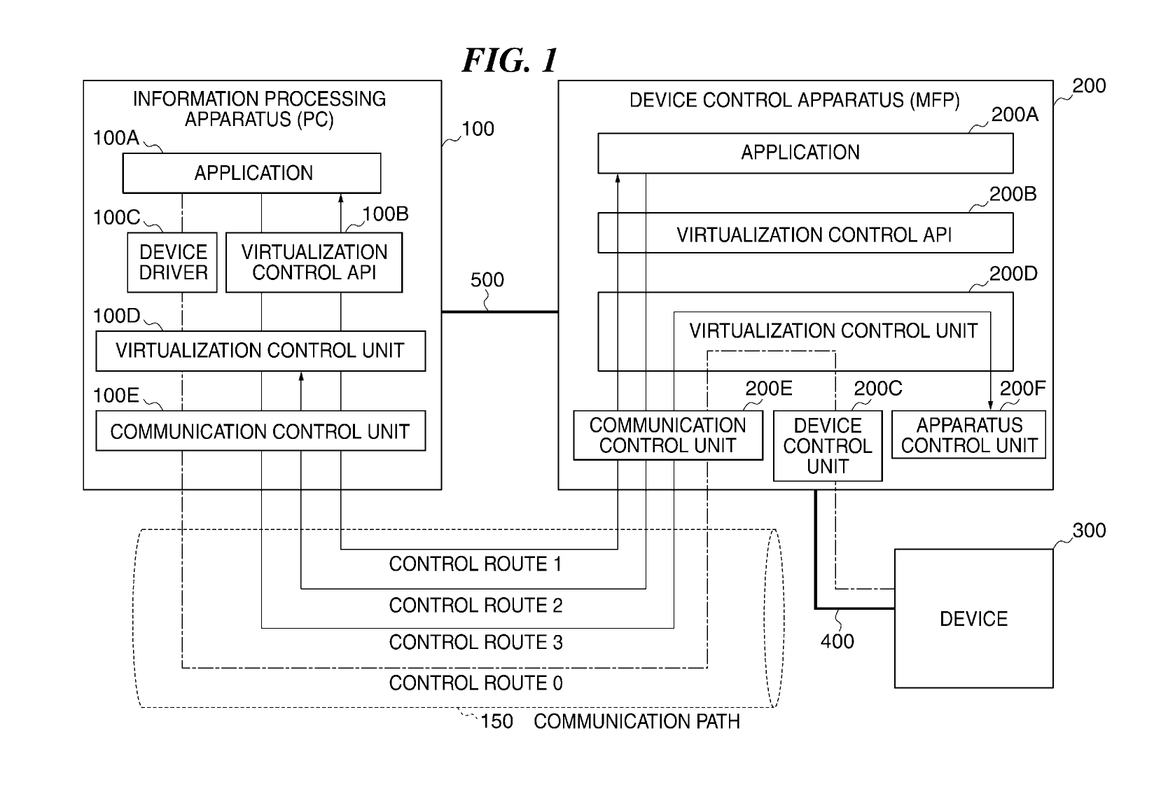

FIG. 1 is a schematic block diagram of a device control system according to a first embodiment of the present invention. FIG. 1 shows a printing system as an example of the device control system.

In the illustrated printing system, an information processing apparatus 100 and a device control apparatus 200 are connected to each other via a network 500. Further, the device control apparatus 200 and a device 300 are connected to each other via a connection cable 400.

In the illustrated example, the information processing apparatus 100 is e.g. a personal computer (PC), and the device control apparatus 200 is e.g. a multifunction peripheral (MFP).

### <<Internal Configuration of Each Apparatus (Software/Hardware Configuration)>>

### <Configuration of Information Processing Apparatus 100>

The information processing apparatus 100 includes, though not shown, a CPU, an input unit, a display unit, a memory, a storage unit, and so forth, as hardware configuration included in a general personal computer, and these components are interconnected by an internal bus.

The CPU is a central processing unit for controlling the components of the information processing apparatus 100. The input unit is an operation unit formed e.g. by a keyboard and a mouse. The display unit is a display device, such as a liquid crystal monitor. The memory is a storage device, such as a RAM and a ROM. The storage unit is a storage device, such as a hard disc drive.

The storage unit stores an operating system (hereinafter referred to as the OS), not shown, a communication control unit 100E, a virtualization control unit 100D, a virtualization control API 100B, a device driver 100C, and an application 100A. The communication control unit 100E, the virtualization control unit 100D, the virtualization control API 100B, the device driver 100C, and the application 100A are loaded into the memory, and operate according to the control of the CPU.

The application 100A is software that controls the device 300 via the device driver 100C. Further, the application 100A is software that performs virtualization control and control using a communication path used in the virtualization control, via the virtualization control API 100B.

The virtualization control API 100B provides the application 100A with an interface (Application Program Interface) for performing the virtualization control and the control using the communication path used in the virtualization control.

Examples of the interface provided by the virtualization control API 100B include interfaces for sending instructions for starting/stopping communication and starting/stopping the virtualization control, transmitting/receiving data to and from an application 200A, and transmitting a control request to an apparatus control unit 200F, described hereinafter, and for receiving a change in an operating state in the information processing apparatus 100, detected by the virtualization control unit 100D, and a change in an operating state, transmitted from the device control apparatus 200.

The device driver 100C is software that generates a control command for the device 300, and transmits the generated command to the virtualization control unit 100D according to instructions from the higher-layer software, such as the OS and the application 100A, and notifies the higher-layer software of a response to the control command from the device 300.

The virtualization control unit 100D is software that performs control to cause the device 300 to appear as if it is directly connected to the information processing apparatus 100. Further, the virtualization control unit 100D performs control instructed via the interface provided by the virtualization control API 100B.

The communication control unit 100E is an interface for connecting the information processing apparatus 100 to a LAN or a WAN (wired or wireless network), which enables the information processing apparatus 100 to perform data transmission and reception to and from the device control apparatus 200.

### <Configuration of Device Control Apparatus 200>

Similar to the information processing apparatus 100, the device control apparatus 200 includes, though not shown, a CPU, an input unit, a display unit, a memory, a storage unit, and so forth, and these components are interconnected by an internal bus.

The storage unit stores an operating system (not shown), a communication control unit 200E, the apparatus control unit 200F, a virtualization control unit 200D, a virtualization control API 200B, a device control unit 200C, and the application 200A, which are software units. The OS, the communication control unit 200E, the apparatus control unit 200F, the virtualization control unit 200D, the virtualization control API 200B, the device control unit 200C, and the application 200A are loaded into the memory, and operate according to the control of the CPU.

The application 200A is software for causing the device control apparatus 200 to perform predetermined functions. Further, the application 200A is capable of controlling the device 300 in cooperation with the application 100A of the information processing apparatus 100 via the virtualization control API 200B.

The virtualization control API 200B provides the application 100A with an interface for performing virtualization control and control using a communication path used in the virtualization control. Then, the virtualization control API 200B sends a control request to the virtualization control unit 200D based on instructions from the application 200A, and notifies the application 200A of a change in an operating state, detected by the virtualization control unit 200D.

Examples of the interface provided by the virtualization control API 200B include interfaces for sending instructions for starting/stopping communication and starting/stopping the virtualization control, transmitting/receiving data to and from the application 100A, and transmitting a control request to the apparatus control unit 200F, and for receiving a change in an operating state in the device control apparatus 200, detected by the virtualization control unit 200D, and a change in an operating state of the device 300, and notifying the application 200A of the received changes.

The device control unit 200C controls the device 300 connected via the connection cable 400.

The virtualization control unit 200D is software that performs control to cause the device 300 to appear as if it is directly connected to the information processing apparatus 100. Further, the virtualization control unit 200D performs control instructed by the interface provided by the virtualization control API 200B.

The communication control unit 200E is an interface for connecting the device control apparatus 200 to a LAN or a WAN (wired or wireless network), which enables the device control apparatus 200 to perform data transmission and reception to and from the information processing apparatus 100.

The apparatus control unit 200F is a component for controlling software, hardware, and firmware in the device control apparatus 200 other than the device control unit 200C of the device control apparatus 200 (which is different depending on the type of the device control apparatus).

### <Configuration of Device 300>

The device 300 is connected to the device control apparatus 200 e.g. by a USB cable. The device 300 is, for example, a peripheral device, such as an IC card reader or a storage, and, similar to the information processing apparatus 100, includes a CPU, an input unit, a memory, a communication control unit, a storage unit, and so forth, and these components are interconnected by an internal bus.

Although in the device control system shown in FIG. 1, one information processing apparatus 100 and one device control apparatus 200 are illustrated, the number of the information processing apparatus 100 and the device control apparatus 200 on the network 500 is not limited to the illustrated example. Further, the information processing apparatus 100 is not limited to the PC, but, for example, the information processing apparatus 100 may be a mobile phone or a mobile terminal.

Further, in the illustrated example in FIG. 1, the device control apparatus 200 and the device 300 are formed as respective separate apparatuses, but may be formed as an integral structure such that the device 300 is accommodated in a casing of the device control apparatus 200.

Further, the communication interfaces provided in the device control apparatus 200 and the device 300 are not limited to USB or HDMI, but may be interfaces conforming to other communication interfaces, such as Thunderbolt.

### <<Description of Control Routes>>

In the device control system shown in FIG. 1, the information processing apparatus 100 and the device control apparatus 200 are connected by a communication path 150. Further, in the illustrated example, control routes 0 to 3 are defined in the communication path 150.

The communication path 150 indicated by a broken line is a communication path established between the information processing apparatus 100 and the device control apparatus 200 when the information processing apparatus 100 performs virtualization control of the device 300. A control route 0 indicated by a two-dot chain line is a route used when the information processing apparatus 100 performs virtualization control of the device 300 via the communication path 150.

Further, control routes 1 to 3 which are indicated by solid lines are routes used when each of the application 100A of the information processing apparatus 100 and the application 200A of the device control apparatus 200 controls the other side using the communication path 150. The application 100A and the application 200A designate which of the control routes 1 to 3 to be used according to details of control, such as connection/disconnection of communication (session), data transmission/reception, a request to (reset of) the device control unit, connection/disconnection of the device, and start/stop of the virtualization control, and instruct the designated control routes to the virtualization control API 100B and the virtualization control API 200B, respectively.

### <<Description of Sequence of Operations of System and Apparatuses>>

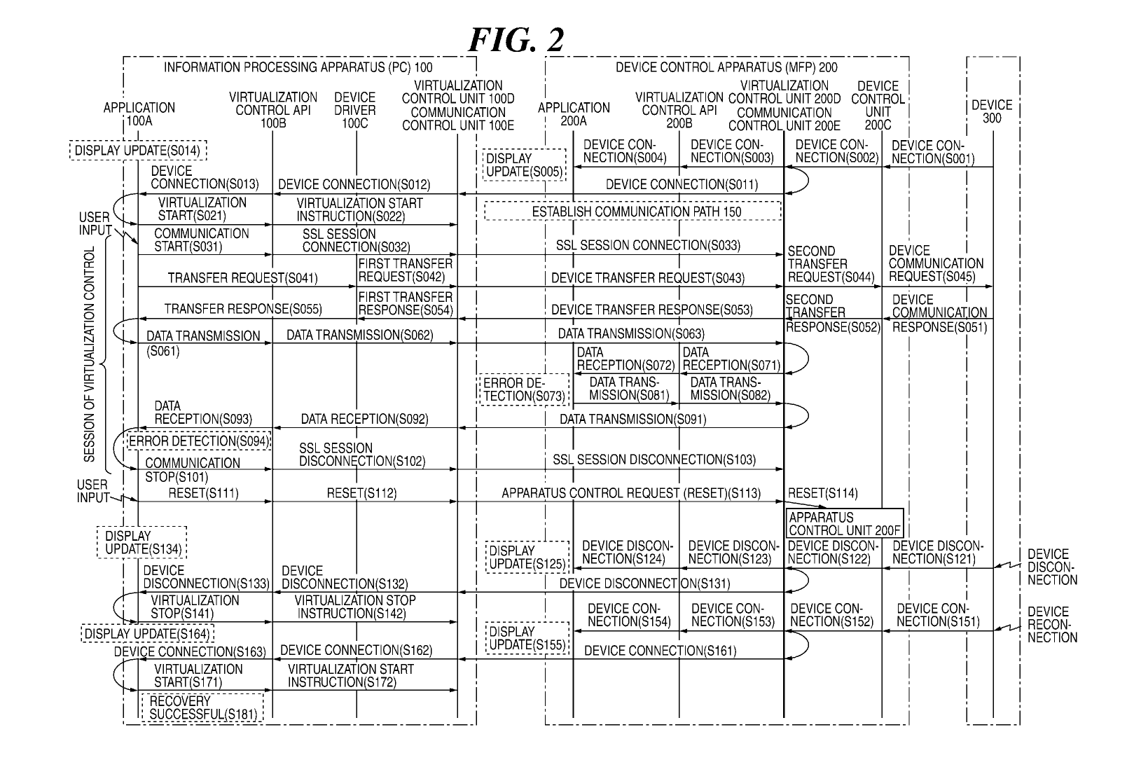

FIG. 2 is a sequence diagram useful in explaining connection/disconnection of a communication (session), transmission/reception of data, a request to (reset of) the apparatus control unit, connection/disconnection of the device, and start/stop of the virtualization control, which are performed via the control routes 0 to 3, in the device control system shown in FIG. 1.

### <1> Detection of Device-Connected State by Device Control Apparatus

First, a description will be given of a sequence until the application 200A of the device control apparatus 200 receives a change in the operating state, which is detected by the virtualization control unit 200D. Note that, here, connection of the device 300 to the device control apparatus 200 is described as the change in the operating state.

Now, when the device 300 is connected to the device control apparatus 200 (step S001), the device control unit 200C detects connection of the device 300, and notifies the virtualization control unit 200D of this fact (step S002). Next, the virtualization control unit 200D notifies the virtualization control API 200B of the detected device connection (step S003). Then, the virtualization control API 200B notifies the application 200A of the device connection (step S004).

Upon receipt of the device connection notification, for example, the application 200A lights (flashes) an LED (Light Emitting Diode) or displays information indicative of the device connection notification on the display unit, such as a LCD (Liquid Crystal Display), to thereby notify that the device 300 has been connected to the device control apparatus 200 (step S005: display update).

### <2> Detection of Device-Connected State by Information Processing Apparatus 100

Next, a description will be given of a sequence until the application 100A of the information processing apparatus 100 receives the above-described change in the operating state (connection of the device 300), which is detected by the virtualization control unit 200D of the device control apparatus 200.

In a step S011, the connection state of the device, detected by the virtualization control unit 200D of the device control apparatus 200, is notified to the information processing apparatus 100 by the communication control unit 200E (step S011). Upon receipt of the device connection notification, the communication control unit 100E of the information processing apparatus 100 transfers the received device connection notification to the virtualization control API 100B via the virtualization control unit 100D (step S012). Then, the virtualization control API 100B sends the device connection notification to the application 100A (step S013).

Then, the application 100A displays information to the effect that the device 300 has been connected to the device control apparatus 200, using the display unit, such as a display (step S014).

Thus, the application 100A of the information processing apparatus 100 is capable of detecting a change in the operating state, i.e. connection of the device 300 to the device control apparatus 200, via the virtualization control API 100B, and displaying the information to the effect that the device 300 has been connected, on the display unit, such as the display.

### <3> Start of Device Virtualization Control Performed By Information Processing Apparatus

Upon receipt of the connection notification in the step S013 as mentioned above, in the information processing apparatus 100, the application 100A determines that it is time to start the virtualization control of the device 300, and instructs the virtualization control API 100B to start the virtualization control (step S021). Then, the virtualization control API 100B instructs the virtualization control unit 100D to start the virtualization control (step S022). At this time, the communication path 150 is established between the communication control unit 100E of the information processing apparatus 100 and the communication control unit 200E of the device control apparatus 200.

With this, the virtualization control unit 100D performs the virtualization control according to the device connection information received in the step S011 such that the device 300 appears as if it is directly connected to the information processing apparatus 100.

Thus, the information processing apparatus 100 establishes the communication path 150 (indicated by the broken line in FIG. 1) between the information processing apparatus 100 and the device control apparatus 200 connected to the network 500 so as to perform the virtualization control of the device 300, and thereby it becomes capable of controlling the device 300 via the device control apparatus 200 connected thereto via the communication path 150, as if the device 300 is directly connected to the information processing apparatus 100.

### <4> Start of Communication by Information Processing Apparatus

Next, a description will be given of a sequence until data communication with the device 300 is started at a time designated by the information processing apparatus 100 having started the virtualization control of the device 300. Note that here, the description is given by taking a case where data communication is started by a user instruction using encrypted communication, as an example.

Note that the information processing apparatus 100 stores in advance information concerning the device 300 which can be connected (e.g. a vendor ID or a product ID), a data encryption method (e.g. AES: Advanced Encryption Standard) which can be set, a communication protocol (e.g. SSL: Secure Socket layer), and information concerning a digital certificate and the like. A user can select these information items by using an input device (not shown), and can perform designation in a case where there are a plurality of devices, encryption types, and certificates.

When the user instructs encrypted communication, the application 100A of the information processing apparatus 100 instructs the virtualization control API 100B to start communication by designating SSL encryption (step S031). This causes the virtualization control API 100B to instruct the virtualization control unit 100D to establish an SSL session (step S032).

Then, the virtualization control unit 100D establishes an SSL session with the communication control unit 200E of the device control apparatus 200, by the communication control unit 100E (step S033).

This enables the information processing apparatus 100 and the device 300 to perform data communication with each other via the device control apparatus 200.

<5> Virtualization Control of Device (from Information Processing Apparatus to Device)

Next, a description will be given of the virtualization control of the device 300 by the information processing apparatus 100 shown in FIG. 1. Here, the control is performed using the control route 0 appearing in FIG. 1.

When a control request is transmitted from the information processing apparatus 100 to the device 300, the control request from the application 100A is transmitted to the device control apparatus 200 via the device driver 100C, the virtualization control unit 100D, and the communication control unit 100E.

More specifically, the application 100A sends a transfer request to the device driver 100C (step S041). The device driver 100C having received the transfer request from the application 100A generates a first transfer request for requesting parameters concerning the device 300, and passes the generated first transfer request to the virtualization control unit 100D (step S042).

The virtualization control unit 100D extracts only parameters to be passed to the virtualization control unit 200D of the device control apparatus 200 from the first transfer request, as the requesting parameters. Then, the virtualization control unit 100D generates a device transfer request including the requesting parameters and device identification information for identifying the device 300. Then, the communication control unit 100E transmits the device transfer request to the device control apparatus 200 (step S043).

On the other hand, upon receipt of the device transfer request from the information processing apparatus 100 via the communication control unit 200E, the device control apparatus 200 identifies the device 300 to which data is to be transferred based on the device identification information included in the received device transfer request by virtualization control unit 200D. Then, the virtualization control unit 200D converts the requesting parameters included in the device transfer request to data in a data format to be passed to the device control unit of the device 300 to thereby generate a second transfer request, and passes the second transfer request to the device control unit 200C (step S044).

The device control unit 200C generates a device communication request based on the received second transfer request, and transmits the generated device communication request to the device 300 (step S045).

Thus, in response to the received device transfer request, the device control apparatus 200 transmits the device communication request to the device 300 connected by the connection cable 400, via the communication control unit 200E, the virtualization control unit 200D, and the device control unit 200C.

<6> Virtualization Control of Device (from Device to Information Processing Apparatus)

Upon receipt of the device communication request from the device control apparatus 200, the device 300 transmits a device communication response responsive to the device communication request to the device control apparatus 200 (step S051). The device control apparatus 200 sends a second transfer response responsive to the device communication response received via the device control unit 200C to the virtualization control unit 200D (step S052).

The virtualization control unit 200D extracts only parameters corresponding to the requesting parameters from the second transfer response as response parameters, and generates a device transfer response including the response parameters. Then, the virtualization control unit 200D transmits the generated device transfer response to the information processing apparatus 100 via the communication control unit 200E (step S053).

In the information processing apparatus 100, upon receipt of the device transfer response from the device control apparatus 200, the communication control unit 100E passes the received device transfer response to the virtualization control unit 100D. Then, the virtualization control unit 100D sends a first transfer response generated by converting the response parameters included in the device transfer response to data in a predetermined data format to the device driver 100C (step S054). Then, the device driver 100C passes the first transfer response to the application 100A (step S055).

Thus, the response from the device 300 is transmitted to the application 100A of the information processing apparatus 100 using the control route 0 appearing in FIG. 1. Here, if communication stop is instructed from the application 100A to the virtualization control API 100B, the virtualization control API 100B disconnects from the device control apparatus 200 using the communication control unit 100E.

<7> Transmission of Card ID from Information Processing Apparatus to Device Control Apparatus

Next, a description will be given of a sequence performed when a data/control request is transmitted to a destination apparatus by causing the application 100A of the information processing apparatus 100 and the application 200A of the device control apparatus 200 to cooperate with each other.

Here, it is assumed that the information processing apparatus 100 is a PC, the device control apparatus 200 is an MFP, and the device 300 is an IC card reader. Further, the description is given by taking as an example a case where data can be transmitted/received to and from the device 300 being subjected to the virtualization control by the information processing apparatus 100, and a card ID acquired by the device 300 is read by the information processing apparatus 100 and is authenticated by the device control apparatus 200.

In this case, data transmission and reception between the information processing apparatus 100 and the device 300 is performed by the same data transmission and reception process as in the above-described steps S041 to S055 using the control route 0 appearing in FIG. 1.

More specifically, when the IC card is held over the device 300, the device 300 acquires a card ID from the IC card, and sends the acquired card ID to the device control apparatus 200. The device control apparatus 200 sends the card ID to the information processing apparatus 100 using the control route which is encrypted by SSL.

Then, in the information processing apparatus 100, the application 100A reads (recognizes) the acquired card ID, and sends the card ID to the device control apparatus 200 in the following steps S061 to S072, and the device control apparatus 200 performs authentication.

In this case, to cause the application 100A of the information processing apparatus 100 and the application 200A of the device control apparatus 200 to perform processing in cooperation with each other, the data transmission and reception is performed using the control route 1 appearing in FIG. 1.

More specifically, in the information processing apparatus 100, the application 100A instructs the virtualization control API 100B to perform data transmission (hereinafter referred to as card ID transmission) to the application 200A of the device control apparatus 200 (step S061).

Next, the virtualization control API 100B requests the virtualization control unit 100D to transmit the card ID (step S062). The virtualization control unit 100D sends the card ID to the device control apparatus 200 via the communication control unit 100E (step S063).

Thus, the information processing apparatus 100 transfers the control request from the application 100A to the virtualization control API 100B, and the virtualization control API 100B transmits the control request (card ID transmission, here) to the device control apparatus 200 via the virtualization control unit 100D and the communication control unit 100E.

On the other hand, in the device control apparatus 200, the communication control unit 200E receives the card ID, and sends the received card ID to the virtualization control unit 200D. Then, the virtualization control API 200B performs data reception (hereinafter referred to as card ID reception) from the virtualization control unit 200D (step S071). The virtualization control API 200B notifies the application 200A of the card ID reception (step S072).

Thus, in the device control apparatus 200, the control request received using the control route 1 is sent to the virtualization control unit 200D via the communication control unit 200E, and the virtualization control unit 200D sends the control request (card ID reception, here) to the application 200A via the virtualization control API 200B.

Thus, when the application 200A of the device control apparatus 200 performs data transmission and reception to and from the application 100A of the information processing apparatus 100, the application 200A is capable of transmitting and receiving the card ID using the communication path 150 which has already been used in the virtualization control without using a new communication path.

<8> Error Notification from Device Control Apparatus to Information Processing Apparatus

Here, a description will be given of a case where an error is detected by the application 200A of the device control apparatus 200 in the above-described card ID authentication process. In this case, data (error detection) is transmitted from the device control apparatus 200 to the information processing apparatus 100 using the control route 1 appearing in FIG. 1.

More specifically, if an error occurs in the device control apparatus 200 due to such a reason that although the card ID has been received as described above, the corresponding card ID is not found in an authentication database provided in the device control apparatus 200, the application 200A detects the error, and displays information indicative of the authentication error on the display unit or the like of the self-apparatus (step S073).

Further, in the device control apparatus 200, the application 200A instructs the virtualization control API 200B to perform data transmission (hereinafter referred to as authentication error notification) so as to notify the authentication error (step S081). Then, the virtualization control API 200B requests the virtualization control unit 200D to perform the authentication error notification (step S082).

Then, the virtualization control unit 200D performs the authentication error notification to the information processing apparatus 100 via the communication control unit 200E (step S091).

Thus, in the device control apparatus 200, using the control route 1 appearing in FIG. 1, the data/control request from the application 200A is sent to the virtualization control API 200B, and the authentication error notification is transmitted from the virtualization control API 200B to the information processing apparatus 100 via the virtualization control unit 200D and the communication control unit 200E.

On the other hand, in the information processing apparatus 100, the virtualization control unit 100D receives the authentication error notification via the communication control unit 100E, and notifies the virtualization control API 100B of reception of the authentication error notification (step S092). Then, the virtualization control API 100B notifies the application 100A of reception of the authentication error notification (step S093).

As described above, each of the information processing apparatus 100 and the device control apparatus 200 can receive a result of an operation or the like, by using the communication path 150 (SSL session) which has already been used in the virtualization control without using a new communication path between the application 100A of the information processing apparatus 100 and the application 200A of the device control apparatus 200.

### <9> Stop of Communication by Information Processing Apparatus

Next, a description will be given of a sequence for stopping communication at a time designated by the application 100A in the information processing apparatus 100, by taking a case where the authentication error is notified in the step S093 as an example.

In the information processing apparatus 100, the authentication error is detected based on the authentication error notification sent from the application 200A of the device control apparatus 200 (step S094), and the application 100A instructs the virtualization control API 100B to stop communication in response to the authentication error notification (step S101).

At this time, in the information processing apparatus 100, the application 100A notifies the error, e.g. by displaying the error on the display unit, such as a display, or by using a sound unit (not shown), such as a buzzer.

Then, the virtualization control API 100B instructs the virtualization control unit 100D to disconnect the communication path (SSL session) (step S102). Then, the virtualization control unit 100D disconnects the communication path (SSL session) with the communication control unit 200E of the device control apparatus 200, by the communication control unit 100E (step S103).

### <10> Reset of Device by Information Processing Apparatus

Here, a description will be given of an example of a case where in the information processing apparatus 100, the application 100A performs reconnection (resetting) of the device 300 by controlling the apparatus control unit 200F of the device control apparatus 200 at a time designated by the user, after the steps S094 to S102.

In this case, in the information processing apparatus 100, the application 100A controls the apparatus control unit 200F (a component for controlling software, hardware, and firmware in the device control apparatus 200 other than the device control unit 200C) via the virtualization control unit 200D of the device control apparatus 200. At this time, the control is performed using the control route 3 appearing in FIG. 1.

More specifically, as described above, in the step S094, the application 100A displays the error in the information processing apparatus 100. The user instructs reset using a UI (User Interface) on the application 100A in response to the error display.

In response to the reset instructions from the user, the application 100A instructs the virtualization control API 100B to perform resetting (step S111). Then, the virtualization control API 100B instructs the virtualization control unit 100D to perform resetting (step S112).

With this, the virtual control unit 100D transmits a device control request (reset) to the device control apparatus 200 (MFP) via the communication control unit 100E (step S113). In the device control apparatus 200 (MFP), the virtualization control unit 200D receives the device control request (reset) via the communication control unit 200E.

Next, in the device control apparatus (MFP) 200, the virtualization control unit 200D instructs the apparatus control unit 200F to perform resetting (step S114).

Here, the apparatus control unit 200F performs control of a hardware bus which cannot be controlled by the device control unit 200C appearing in FIG. 1. For example, the device 300 has the magnitude of current of power supplied thereto via a USB interface limited by a high-side switch (hereinafter referred to as the USB high-side switch), and the apparatus control unit 200F sends reset instructions to the USB high-side switch. This causes the apparatus control unit 200F to perform off/on control of the USB high-side switch to thereby reset the device control unit 200C (USB host controller).

That is, by controlling the apparatus control unit 200F, it is possible to perform an operation similar to physical insertion/removal of the connection cable 400 that connects the device 300 and the device control apparatus 200.

Note that, it is possible to give instructions to the apparatus control unit 200F via the virtualization control API 100B, so as to control not only the above-mentioned USB high-side switch, but also software, hardware, and firmware in the device control apparatus 200 other than the device control unit 200C of the device control apparatus 200 from the virtualization control API 100B of the information processing apparatus 100.

That is, the data/control request from the application of the self-apparatus is transmitted to the destination apparatus via the virtualization control API, whereby it is possible to control the software, the hardware, and the firmware in the mating apparatus via the virtualization control unit of the mating apparatus. This makes it possible to provide a solution by cooperating with various functions provided in the device control apparatus 200.

### <11> Detection of Recovery of Device by Information Processing Apparatus

Here, a description will be given of an example of a recovery operation performed after the reset control has been performed in the steps S111 to S114.

When the device 300 is once disconnected by the reset control performed in the steps S111 to S114, in the device control apparatus 200, the device control unit 200C detects disconnection from the device 300 (step S121) and notifies the virtualization control unit 200D of this fact (step S122).

The virtualization control unit 200D notifies the virtualization control API 200B of the disconnection from the device 300 (step S123). Then, the virtualization control API 200B notifies the application 200A of the disconnection from the device 300 (step S124). This cause the device control apparatus 200 to display information to the effect that the device 300 has been disconnected, on the display unit, such as a LED/LCD (step S125).

Further, in the device control apparatus 200, the virtualization control unit 200D notifies the information processing apparatus 100 of the detected disconnection from the device 300 via the communication control unit 200E (step S131). In the information processing apparatus 100, the device disconnection notification received by the communication control unit 100E is sent to the virtualization control API 100B via the virtualization control unit 100D (step S132).

The virtualization control API 100B notifies the application 100A of the disconnection from the device (step S133). This causes the application 100A to display information to the effect that the device 300 has been disconnected, on the display unit, such as a display (step S134).

Then, in the information processing apparatus 100, the application 100A judges the disconnection from the device as a time to stop the virtualization control, and instructs the virtualization control API 100B to stop the virtualization control (step S141). Then, the virtualization control API 100B instructs the virtualization control unit 100D to stop the virtualization control (step S142). This causes the virtualization control unit 100D to stop the virtualization control, and thereby disconnect between the information processing apparatus 100 and the device 300.

When the device 300 is once disconnected by the reset control performed in the step S114, and then is reconnected, in the device control apparatus 200, the device control unit 200C detects reconnection of the device 300 (step S151), and notifies the virtualization control unit 200D of this fact (step S152). Then, the virtualization control unit 200D notifies the virtualization control API 200B of the connection of the device 300 (step S153).

Next, the virtualization control API 200B notifies the application 200A of the connection of the device 300 (step S154). This causes the device control apparatus 200 to display information to the effect that the device 300 has been connected, on the display unit, such as the LED/LCD (step S155).

Further, the device control apparatus 200 notifies the information processing apparatus 100 of the connection of the device, detected by the virtualization control unit 200D, via the communication control unit 200E (step S161). In the information processing apparatus 100, the device connection notification received by the communication control unit 100E is sent to the virtualization control API 100B via the virtualization control unit 100D (step S162).

Next, the virtualization control API 100B sends the device connection notification to the application 100A (step S163). This causes the application 100A to display information to the effect that the device 300 has been connected, on the display unit, such as the display (step S164).

Next, in the information processing apparatus 100, the application 100A judges the connection of the device as a time to start the virtualization control, and instructs the virtualization control API 100B to start the virtualization control (step S171). This causes the virtualization control API 100B to instruct the virtualization control unit 100D to start the virtualization control (step S172). The virtualization control unit 100D starts the virtualization control such that the device 300 appears as if it is directly connected to the information processing apparatus 100. Thus, device disconnection and reconnection is performed after the reset is instructed by the application 100A, and when the virtualization control is started, the application 100A judges that the recovery is successful (step S181).

### Advantageous Effects Provided by First Embodiment

As described above, in the first embodiment of the present invention, the application 100A and the application 200A can perform data transmission and reception using the communication path which has already been used in the virtualization control without newly providing a communication path. Particularly, in a case where it is necessary to perform encrypted communication via a network, it is possible to perform a necessary procedure for encryption, such as exchange of an encryption key/certificate, by using the communication path, and hence it is possible to reduce time required to start communication.

Further, as the network port used for communication by the device 300, described in the first embodiment, the port number (Registered Port Numbers) registered in IANA (Internet Assigned Number Authority) is used. Therefore, when securing a new communication path, the port number (Private Port Numbers) which can be freely used by the user is used. At this time, it is possible that the port number has already been used, and hence it is necessary to check whether or not the port number is duplicated. However, as described above, in the first embodiment, communication is performed using the communication path which has already been used in the virtualization control, and hence it becomes unnecessary to check whether or not the port number is duplicated.

Further, by using the communication path which has already been used in the virtualization control, the application 100A is capable of determining connection/disconnection of the device 300 and starting/stopping the virtualization control by the virtualization control API.

Further, the application 100A can start or stop communication with the device control apparatus 200 by designating the device 300, the encryption type, and the certificate via the virtualization control API 100B at a time of a user input to the information processing apparatus 100 or the like which can be detected by the application 100A.

In addition, the application 100A is capable of causing control of the software, hardware, and firmware in the device control apparatus 200 other than the device control unit 200C of the device control apparatus 200 (e.g. resetting of the device) to be performed via the virtualization control API 100B at a time of a user input to the information processing apparatus 100 or the like which can be detected by the application 100A.

### Second Embodiment

Next, a description will be given of an example of a device control system according to a second embodiment of the present invention. Note that the device control system according to the second embodiment has the same configuration as that of the device control system shown in FIG. 1.

The second embodiment differs from the first embodiment in that an application of a device control apparatus performs virtualization control and connection control using a virtualization control API, in cooperation with an information processing apparatus. Component elements having the same functions as those of the first embodiment are denoted by the same reference symbols or numerals, and description thereof is omitted.

### <<Description of Sequence of Operations of System and Apparatuses>>

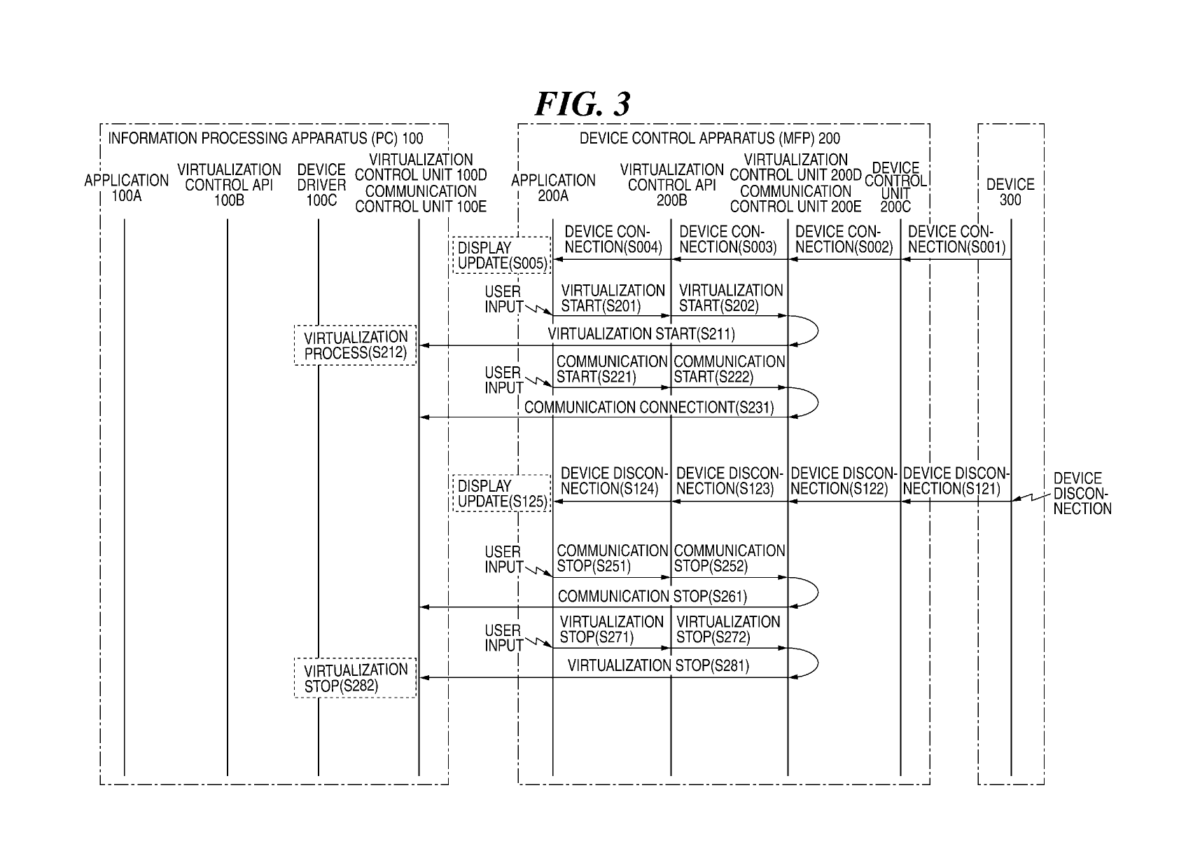

FIG. 3 is a diagram useful in explaining a sequence performed when the virtualization control is started by the device control apparatus 200 in the device control system according to the second embodiment of the present invention.

Here, the virtualization control unit 100D of the information processing apparatus 100 is controlled from the application 200A of the device control apparatus 200 using the communication path 150. At this time, the control is executed using the control route 2 appearing in FIG. 1.

Note that a sequence from the step S001 in which the device is connected up to the step S005 in which device connection is detected, described with reference to FIG. 2, is the same as that of the first embodiment.

<12> Start of Virtualization Control by Input from Device Control Apparatus

Here, a description will be given of a sequence in which the application 200A of the device control apparatus 200 starts the virtualization control at a designated time in cooperation with the virtualization control unit 100D of the information processing apparatus 100. This sequence is started by a user input to the device control apparatus 200.

The device control apparatus 200 stores in advance information processing apparatus information concerning the information processing apparatus 100 which can be connected, and a user is capable of selecting the device 300 and the information processing apparatus 100 as a connection destination, using an input device. In a case where there are a plurality of devices and information processing apparatuses, the user can designate a desired device and information processing apparatus. The information processing identification information mentioned here is information for identifying the information processing apparatus 100. For example, the information processing apparatus information includes a computer name, an IP address, a MAC address, a serial number (production number), and so forth of the information processing apparatus 100, but is not limited to these information items. Further, the information processing apparatus information may be a combination of these information items.

First, in the device control apparatus 200, the application 200A receives a user input (here, information processing apparatus information concerning device information of selection of the device 300 and the information processing apparatus 100). Then, the application 200A notifies the virtualization control API 200B of the user input for starting the virtualization control (step S201).

Then, the virtualization control API 200B instructs the virtualization control unit 200D to start the virtualization control (step S202). The virtualization control unit 200D transmits a virtualization control start to the information processing apparatus 100 via the communication control unit 200E (step S211). Then, the virtualization control unit 100D performs connection for the virtualization control to thereby perform connection for the information processing apparatus 100 and the device 300 based on the information concerning the selection of the device 300, received in the step S211 (step S212).

Thus, it is possible to perform the virtualization control process by designating a desired devices and information processing apparatus from the device control apparatus 200.

<13> Start of Communication by Input from Device Control Apparatus

Here, a description will be given of a sequence for starting communication at a time designated by the application 200A of the device control apparatus 200. This sequence is started by a user input to the device control apparatus 200.

The device control apparatus stores in advance device information of the device 300 which can be connected and encryption types which can be set and certificates, and the user can select the device 300, the encryption type (SSL/AES or the like), and the certificate, using the input device. When there are a plurality of information processing apparatuses, devices, encryption types, and certificates, the user can designate a desired device, information processing apparatus, encryption types, and certificate.

First, in the device control apparatus 200, the application 200A receives a user input (here, the device information indicative of selection of the device 300, the encryption type, and the certificate). This causes the application 200A to notify the virtualization control API 200B of the start of communication (step S221).

The virtualization control API 200B instructs the virtualization control unit 200D to start communication (step S222). Then, the virtualization control unit 200D performs communication connection via the communication control unit 200E to the information processing apparatus 100 that is performing virtualization control of the device 300 designated by the application 200A, using the designated encryption type and the designated certificate (step S231).

Thus, it is possible to perform communication connection by designating a desired device, information processing apparatus, network encryption, and certificate, from the device control apparatus 200.

Note that the user inputs concerning virtualization control connection and communication connection are not necessarily required to be separated. Further, the steps S121 to S125 are the same as those of the first embodiment.

<14> Stop of Communication by Input from Device Control Apparatus

Here, a description will be given of a sequence for stopping communication at a time designated by the application 200A of the device control apparatus 200. This sequence is started by a user input to the device control apparatus 200.

First, in the device control apparatus 200, the application 200A receives a user input (here, device information indicative of selection of the device 300). This causes the application 200A to notify the virtualization control API 200B of a communication stop (step S251).

Then, the virtualization control API 200B instructs the virtualization control unit 200D to stop communication (step S252). Then, the virtualization control unit 200D transmits instructions for stopping communication to the information processing apparatus 100 that is performing the virtualization control of the device 300 (step S261).

Thus, it is possible to stop communication by designating a desired device and information processing apparatus from the device control apparatus 200.

<15> Stop of Virtualization Control by Input from Device Control Apparatus

Here, a description will be given of a sequence in which the application 200A of the device control apparatus 200 stops the virtualization control at a designated time in cooperation with the virtualization control unit 100D of the information processing apparatus 100. This sequence is started by a user input to the device control apparatus 200.

First, in the device control apparatus 200, the application 200A receives a user input (here, device information indicative of selection of the device 300). This causes the application 200A to notify the virtualization control API 200B of a virtualization control stop (step S271). The device information mentioned here is, for example, information for identifying the device 300, and includes a vendor ID (VID) assigned to each manufacturer that manufactured the device, for identification of the manufacturer, a product ID (PID) assigned to each device type for identifying the device type, a serial number assigned to each individual device for identifying the individual device, and so forth. The device control unit 200C acquires the device information from the device 300 e.g. when the device 300 is connected to the device control apparatus 200.

Next, the virtualization control API 200B instructs the virtualization control unit 200D to stop the virtualization control (step S272). Then, the virtualization control unit 200D transmits instructions for stopping the virtualization control of the device 300 to the information processing apparatus 100 that is performing the virtualization control of the device 300 (step S281). This causes the virtualization control unit 100D of the information processing apparatus 100 to stop the virtualization control of the device 300 (step S282).

Thus, it is possible to perform processing for stopping the virtualization control by designating a desired device and information processing apparatus from the device control apparatus 200. Note that the user inputs concerning the virtualization control stop and the communication stop are not necessarily required to be separated.

### Advantageous Effects Provided by Second Embodiment

As described above, in the second embodiment of the present invention, it is possible to start or stop the virtualization control from the device control apparatus by selecting a desired device and a desired information processing apparatus by a user input.

Further, it is also possible to perform processing for communication connection or disconnection by selecting whether or not network encryption is to be performed (supportable encryption type/certificate, and the like) with respect to a session of the device designated by the user input from the device control apparatus.

### Third Embodiment

Next, a description will be given of an example of a device control system according to a third embodiment of the present invention. Note that the device control system according to the third embodiment has the same configuration as that of the device control system shown in FIG. 1.

The third embodiment differs from the first embodiment in that an application of a device control apparatus controls hardware other than a device using a virtualization control API. Component elements having the same functions as those of the first embodiment are denoted by the same reference symbols or numerals, and description thereof is omitted.

### <<Description of Sequence of Operations of System and Apparatus>>

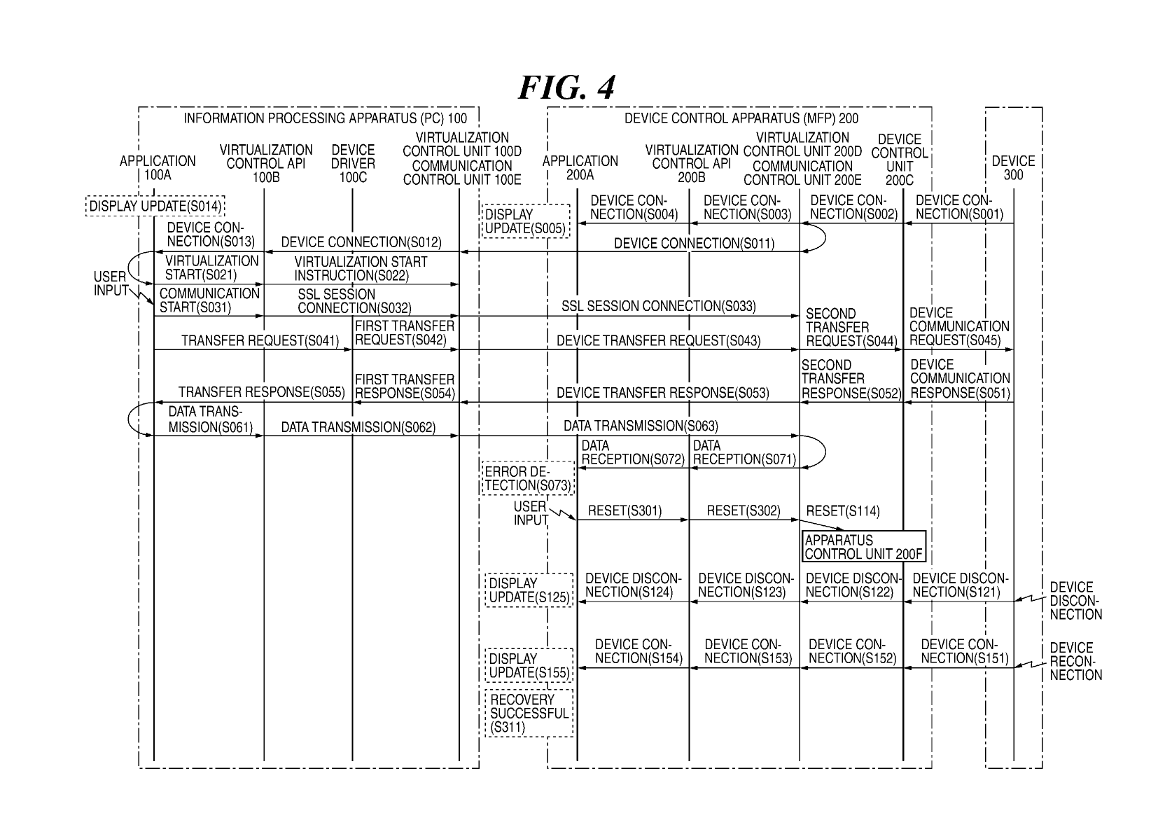

FIG. 4 is a sequence diagram useful in explaining application control and hardware control of the device control apparatus using a virtualization control communication path, in the device control system according to the third embodiment of the present invention.

Here, a description will be given of a sequence in which the application 200A of the device control apparatus 200 instructs the apparatus control unit 200F to operate. This sequence is started by a user input (device reset instructions) to the device control apparatus 200.

Note that a sequence from the step S001 in which the device is connected up to the step S073 in which an error is detected, described with reference to FIG. 2, is the same as that of the first embodiment.

<16> Reset of Device by Input from Device Control Apparatus

The user instructs resetting of the device from the device control apparatus 200 according to the information of error display (step S073) on the device control apparatus 200. Upon receipt of this instruction, the application 200A instructs the virtualization control API 200B to reset the device (step S301).

Next, the virtualization control API 200B instructs the virtualization control unit 200D to reset the device (step S302). This causes the virtualization control unit 200D to instruct the apparatus control unit 200F to reset the device in the same manner as in the first embodiment (step S114).

### <17> Confirmation of Recovery by Display Unit of Device Control Apparatus

In the steps S121 to S125, the device control apparatus 200 detects disconnection from the device 300, and displays information indicative of this fact on the display unit in the same manner as in the first embodiment. Further, in the steps S151 to S155, the device control apparatus 200 detects reconnection of the device 300, and displays information indicative of this fact on the display unit in the same manner as in the first embodiment.

Then, after the device 300 is once disconnected from the device control apparatus 200, when the device 300 is connected to the device control apparatus 200 again, the application 200A judges from this that recovery is successful (step S311).

Note that similar to the first embodiment, recovery may be determined by also performing the virtualization control.

### Advantageous Effects Provided by Third Embodiment

As described above, in the third embodiment of the present invention, it is possible to perform device control (e.g. device reset) on other than the device control unit at a time designated e.g. by a user input not only from the information processing apparatus 100, but also from the device control apparatus 200. That is, it is possible to cause the virtualization control API of the self-apparatus to perform device control (of software, hardware, and firmware) within the self-apparatus.

### Other Embodiments

The present invention is not limited to the above-described embodiments, but it is to be understood that the invention includes various forms within the scope of the gist of the present invention.

For example, a plurality of virtualization control APIs may be provided on a control route-by-control route basis, and the application may select which virtualization control API (i.e. the control route) to be used.

For example, the device control system may be formed by a plurality of information processing apparatuses 100 or a plurality of device control apparatuses 200, or the device control system may be formed by providing both the information processing apparatus 100 and the device control apparatus 200 in plurality.

In this case, the various controls including the following processes described hereafter by way of example can be performed by switching the communication path between the information processing apparatus 100 and the device control apparatus 200, which is used in the virtualization control.

(1) The device control apparatus receives data from an information processing apparatus A via a communication path A, and the virtualization control API of the device control apparatus changes the communication path, and transmits the received data to an information processing apparatus B via a communication path B for communication with the information processing apparatus B.

(2) The information processing apparatus receives data from a device control apparatus A via the communication path A, and the virtualization control API of the information processing apparatus changes the communication path, and transmits the received data to the information processing apparatus B via the communication path B for communication with the device control apparatus B.

(3) In a case where a plurality of information processing apparatuses and device control apparatuses are provided, it is also possible to perform the control by combining the above-mentioned (1) and (2).

As described above, in the embodiments of the present invention, the information processing apparatus and the device control apparatus are each provided with apparatus control units (virtualization control API), whereby it is possible to cause the applications which are higher-layer software of the virtualization control units to cooperate with each other by using the communication path which has already been used in the virtualization control. Further, it is possible to control the apparatus control unit of the device control apparatus from the application installed in the information processing apparatus.

Note that with functions of the above-described embodiments as a control method, and causing the information processing apparatus or the device control apparatus to perform the control method is also one aspect of the present invention.

Further, with a program having the functions of the above-described embodiments as a control program, the control program may be caused to be executed by a computer provided in the information processing apparatus or the device control apparatus.

The control program is stored e.g. in a computer-readable storage medium.

Aspects of the present invention can also be realized by a computer of a system or apparatus (or devices such as a CPU or MPU) that reads out and executes a program stored in a memory device so as to realize the functions of the above-described embodiments, and by a method the steps of which are performed by a computer of a system or apparatus through e.g. reading out and executing a program recorded stored in a memory device so as to realize the functions of the above-described embodiments. For this purpose, the program is provided to the computer, for example, via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

### INDUSTRIAL APPLICABILITY

The present invention, which is applied to a system in which a client (information processing apparatus) uses a device via a network and the client virtually recognizes the device on the network as a device which is locally connected to thereby make it possible to access the device from the client on the network, makes it possible to control the device by causing applications of the client and a device server (device control apparatus) to cooperate with each other by using a communication path between the client and the device server, which is used in virtualization control, and further makes it possible to control software, hardware, and firmware in the device server other than a device control unit of the device server, and hence the present invention is useful in such a system as described above.

This application is a bypass continuation application of PCT International Application PCT/JP2013/085025 filed on Dec. 19, 2013 which is based on and claims priority from Japanese Patent Application No. 2012-279336, filed Dec. 21, 2012, the contents of which are hereby incorporated by reference herein in its entirety.

What is claimed is:

1. An information processing apparatus that is connected via a network to a device control apparatus having a device locally connected thereto, comprising:
a processer configured to execute:
a first virtualization control task that establishes a communication path with the device control apparatus, and performs virtualization control of the device connected to the device control apparatus;
a first control task that controls the device being subjected to the virtualization control by said first virtualization control task, or the device control apparatus; and
a first apparatus control task that selects, in a case where the communication path is established by said first virtualization control task, a predetermined control route according to an instruction from said first control task, and performs transmission and reception of data via the control route.

2. A device control apparatus connected to an information processing apparatus via a network and having a device locally connected thereto, comprising:
a processor configured to execute:
a second virtualization control task that establishes a communication path with the information processing apparatus, and performs virtualization control of the device connected to the device control apparatus;
a second control task that controls the device being subjected to the virtualization control by said second virtualization control task, or the information processing apparatus; and
a second apparatus control task that selects, in a case where the communication path is established by said second virtualization control task, a predetermined control route according to an instruction from said second control task, and performs transmission and reception of data via the control route.

3. The device control apparatus according to claim 2, wherein said second apparatus control task starts or stops the virtualization control of a device by the information processing apparatus, according to a first request from said second control task.

4. A device control system including an information processing apparatus and a device control apparatus having a device locally connected thereto, which are connected to each other via a network,
the information processing apparatus comprising:
a processer configured to execute:
a first virtualization control task that establishes a communication path with the device control apparatus, and performs virtualization control of the device connected to the device control apparatus;
a first control task that controls the device being subjected to the virtualization control by said first virtualization control task, or the device control apparatus; and
a first apparatus control task that selects, in a case where the communication path is established by said first virtualization control task, a predetermined control route according to an instruction from said first control task, and performs transmission and reception of data via the control route, and
the device control apparatus comprising:
a processor configured to execute:
a second virtualization control task that establishes a communication path with the information processing apparatus, and performs virtualization control of the device connected to the device control apparatus;
a second control task that controls the device being subjected to the virtualization control by said second virtualization control task, or the information processing apparatus; and
a second apparatus control task that selects, in a case where the communication path is established by said second virtualization control task, a predetermined control route according to an instruction from said second control task, and performs transmission and reception of data via the control route; and
a third apparatus control task that controls inside the device control apparatus,
wherein the first control route passes through said first control task, said first apparatus control task, said first virtualization control task, said second virtualization control task, said second apparatus control task, and said second control task,
wherein the second control route passes through said first virtualization control task, said second virtualization control task, said second apparatus control task, and said second control task, and
wherein the third control route passes through said first control task, said first apparatus control task, said first virtualization control task, said second virtualization control task, and said third apparatus control task.

5. A method of controlling an information processing apparatus that is connected via a network to a device control apparatus having a device locally connected thereto, comprising:
a first virtualization control step for establishing a communication path with the device control apparatus, and performing virtualization control of the device connected to the device control apparatus;
a first control step for controlling the device being subjected to the virtualization control by said first virtualization control step, or the device control apparatus; and
a first apparatus control step for selecting, in a case where the communication path is established by said first virtualization control step, a predetermined control route according to an instruction from said first control step to perform transmission and reception of data via the control route. 10

6. A method of controlling a device control apparatus connected to an information processing apparatus via a network and having a device locally connected thereto, comprising:
a second virtualization control step for establishing a communication path with the information processing apparatus, and performing virtualization control of the device connected to the device control apparatus;
a second control step for controlling the device being subjected to the virtualization control by said second virtualization control step, or the information processing apparatus; and
a second apparatus control step for selecting, in a case where the communication path is established by said second virtualization control step, a predetermined control route according to an instruction from said second control step to perform transmission and reception of data via the control route.
